(19) United States
(12) Patent Application Publication
(10) Pub. No.: US 2012/0237262 A1
(43) Pub. Date: Sep. 20, 2012

(54) HEAT RADIATING DEVICE, OPTICAL SCANNING APPARATUS, AND IMAGE FORMING APPARATUS

(76) Inventors: Manabu Matsuo, Osaka-shi (JP); Ryosuke Sasaki, Osaka-shi (JP)

(21) Appl. No.: 13/422,310

(22) Filed: Mar. 16, 2012

(30) Foreign Application Priority Data
Mar. 17, 2011 (JP) 2011-059724

(51) Int. Cl. G03G 15/04; H05B 6/00; G02B 26/10

(52) U.S. Cl. 399/177; 359/216.1; 392/407

(57) ABSTRACT

A heat radiating device includes a base on which a heat generating member is mounted and a plurality of heat radiating members that integrally extend from a bottom face of the base. In this heat radiating device, the heat radiating members are each formed to have a circular transverse section, and are arranged such that any one of the heat radiating members is positioned on a straight line in any direction orthogonal to a direction in which the heat radiating members extend.

### CROSS-REFERENCE TO RELATED APPLICATION

This application claims priority under 35 U.S.C. §119(a) on Patent Application No. 2011-059724 filed in Japan on Mar. 17, 2011, the entire contents of which are herein incorporated by reference.

### BACKGROUND OF THE INVENTION

1. Field of the Invention

The present invention relates to a heat radiating device provided with a plurality of heat radiating members that integrally extend from a bottom face of a base on which a heat generating member is mounted, an optical scanning apparatus provided with the heat radiating device, and image forming apparatus provided with the optical scanning apparatus.

2. Description of the Related Art

Conventionally, various heat radiating devices provided with a plurality of heat radiating members that integrally extend from a bottom face of a base on which a heat generating member is mounted are proposed (see JP 2005-252175A (hereinafter, referred to as Patent Document 1), for example).

Patent Document 1 discloses a heat blocking member 105 provided with a heat blocking plate 151 and a partition plate 152 that is disposed on a back face of the heat blocking plate 151, and a plurality of heat radiating fins (heat radiating members) 153 are arranged upright on the back face of the heat blocking plate 151. FIGS. 15A to 15C show the shape and the arrangement structure of the heat radiating fins 153 that are arranged on the back face of the heat blocking plate 151.

In a first example shown in FIG. 15A, heat radiating fins 153A each have a rectangular cross-section. The heat radiating fins 153A that are arranged in regions S1 and S2 are arranged such that their longitudinal direction is in the vertical direction, and the heat radiating fins 153A that are arranged in regions S3 and S4 and at the center are arranged such that their longitudinal direction is in the lateral direction. That is to say, the heat radiating fins 153A are arranged such that, in the cross-section, the longer sides are oriented toward the center.

In a second example shown in FIG. 15B, columnar heat radiating fins 153B are arranged in an evenly spaced manner in vertical rows and lateral rows. Furthermore, the rows of the heat radiating fins 153B are alternately shifted vertically and laterally.

In a third example shown in FIG. 15C, heat radiating fins 153C are formed so as to radially extend along lines radiating from the center of the heat blocking plate 151, providing a structure in which convective air currents easily flow in radial directions.

However, in the arrangement of the heat radiating fins 153A shown in FIG. 15A, the area in which air currents are received by the heat radiating fins 153A varies depending on the air flow orientation, and, thus, the heat radiation effect varies depending on the air flow orientation. Furthermore, since the heat radiating fins 153A each have a rectangular cross-section, and are arranged such that, in the cross-section, the longer sides are oriented toward the center, air currents are squarely received by the longer sides of the heat radiating fins 153A. Accordingly, air currents hardly reach the heat radiating fins 153A that are arranged away from the center, and the heat radiation efficiency becomes poor.

Furthermore, in the arrangement of the heat radiating fins 153B shown in FIG. 15B, although air currents that flow in the lateral direction of the drawing flow through between the heat radiating fins 153B while hitting all heat radiating fins 153B, air currents that flow in the vertical direction of the drawing flow through in straight lines because straight air flow paths are formed. That is to say, the heat radiation effect varies depending on the air flow orientation.

Furthermore, in the arrangement of the heat radiating fins 153C shown in FIG. 15C, since air flow paths are radially formed for air currents that radially flow from the center, air currents flow through in straight lines. Accordingly, the heat radiation efficiency becomes poor.

Meanwhile, in an optical scanning apparatus provided with a rotating polygonal mirror (a heat generating member) that deflects and scans laser beams from a light source, these heat radiating devices are used for cooling down the vicinity of the rotating polygonal mirror. More specifically, in the optical scanning apparatus, these heat radiating devices are arranged on a bottom face of a base on which the rotating polygonal mirror (the heat generating member) is mounted. The optical scanning apparatus may have various arrangement structures according to the machine type of the image forming apparatus in which the optical scanning apparatus is mounted, and, thus, the arrangement structure of the rotating polygonal mirror for the base has to vary according to the machine type.

That is to say, the direction of air currents that flow through a mounted heat radiating device varies depending on the machine type of the optical scanning apparatus, and, thus, the heat radiating device also has to have a heat radiating fin arrangement structure that provides an optimal heat radiation effect for each machine type of the optical scanning apparatus.

In the heat radiating device according to Patent Document 1, the heat radiating fins are arranged in a regular manner, and the arrangement of the heat radiating fins is such that an optimal heat radiation effect is efficiently obtained when air currents are radially sent from the center of the heat radiating device. However, when the heat radiating device is mounted in the optical scanning apparatus, the flow of air currents does not radially spread from the center, and, moreover, even when air currents enter the heat radiating device from a side and flow through the device from the opposite side, the directions in which air currents enter and flow through the device vary depending on the machine type of the optical scanning apparatus in which the heat radiating device is mounted. Thus, an optimal arrangement structure of the heat radiating fins has to be determined for each machine type of the optical scanning apparatus. That is to say, the arrangement of the heat radiating fins has to be designed for each machine type of the optical scanning apparatus, which increases the cost. In other words, it is difficult for the heat radiating devices having the same arrangement structure to be commonly used for all machine types of optical scanning apparatuses.

Furthermore, in the optical scanning apparatus, the rotating polygonal mirror may be covered by a cover casing in order to prevent dirt, dust, or the like from being attached to the surface of the rotating polygonal mirror. In this case, since the rotating polygonal mirror rotates at high speed in a narrow space, the temperature inside the cover casing increases. Conventionally, no special treatment has been applied to a joint face between the cover casing and the base, and, thus, slight unevenness on the joint face reduces the joint area, resulting in insufficient heat radiation effect, that is, insufficient thermal conduction from the cover casing to the base.

### SUMMARY OF THE INVENTION

The present invention was made in view of the above-described circumstances, and it is an object thereof to provide a heat radiating device that can constantly provide heat radiation efficiency without being affected by the air flow direction, and that, even in a case where the heat radiating device is mounted in various machine types of apparatuses having different air blowing directions, can be commonly used for all machine types regardless of the air blowing direction, an optical scanning apparatus provided with the heat radiating device, and image forming apparatus provided with the optical scanning apparatus.

In order to solve the above-described problems, the present invention is directed to a heat radiating device, including: a base on which a heat generating member is mounted; and a plurality of heat radiating members that integrally extend from a bottom face of the base; wherein the heat radiating members are each formed to have a circular transverse section, and are arranged such that any one of the heat radiating members is positioned on a straight line in any direction orthogonal to a direction in which the heat radiating members extend.

When the heat radiating members are arranged on the bottom face of the base in this manner such that the heat radiating members are positioned on a straight line in any direction orthogonal to the direction in which the heat radiating members extend, the area in which air currents are received by the heat radiating members increases, the heat radiation efficiency increases, and the degree of freedom in designing the arrangement of the heat radiating device increases. Furthermore, since the heat radiating members each have a circular transverse section, air that flows through between the heat radiating members flows smoothly, and air (air current) is uniformly brought into contact with all the heat radiating members, and, thus, the heat radiation efficiency can be increased.

Furthermore, the heat radiating device of the present invention may further include a heat radiating portion that is in contact with tip ends of the heat radiating members, and a portion corresponding to a side area between the heat radiating portion and the base may be an open portion that is fully open.

When the heat radiating portion is disposed in this manner, an air flow path is formed such that air (air current) that flows through between the base and the heat radiating portion always flows through between the heat radiating members, and, thus, the heat radiation effect through the heat exchange can be increased. Furthermore, since the heat radiating portion is in contact with the heat radiating members, the heat radiation effect through the thermal conduction from heat radiating members to the heat radiating portion also can be obtained.

Furthermore, in the heat radiating device of the present invention, an air flow path casing that accommodates the heat radiating members and forms an air flow path may be provided on the bottom face of the base, and an air blowing portion that draws outside air from one opening portion to another opening portion of the air flow path casing may be provided near the air flow path casing.

When the air flow path casing that functions as an air blowing path is provided so as to entirely cover the heat radiating members, and the air blowing portion is provided in this manner, the outside air can be efficiently guided to the heat radiating members. Accordingly, the heat radiation effect by the heat radiating members can be further increased.

Furthermore, in the heat radiating device of the present invention, a cover casing that accommodates the heat generating member may be provided on an upper face of the base, and a joint face between the cover casing and the base may be formed as a smooth face.

When the joint face between the cover casing and the base is formed as a smooth face in this manner by mirror finish, the joint area increases, the thermal conduction from the cover casing via the base to the heat radiating members can be more efficiently performed, and, thus, the effect of cooling down the heat generating member can be increased.

Furthermore, the present invention is directed to an optical scanning apparatus, including the heat radiating device according to the above-described aspect of the present invention, wherein the heat generating member is a rotating polygonal mirror that deflects and scans a laser beam from a light source.

When the heat radiating device is disposed in this manner on the bottom face side of the base on which the rotating polygonal mirror is mounted, heat generated in the vicinity of the rotating polygonal mirror that rotates at high speed can be efficiently radiated. In particular, in the case where the cover casing is disposed in order to prevent dirt, dust, or the like from being attached to the rotating polygonal mirror, heat accumulates in the cover casing that is a limited space. However, when the heat radiating device of the present invention is disposed, the heat inside the cover casing can be efficiently radiated.

Furthermore, the present invention is directed to image forming apparatus, including: the optical scanning apparatus according to an aspect of the present invention; an image carrier; a development unit that develops, into a toner image, an electrostatic latent image that has been formed by the laser beam from the optical scanning apparatus scanning a face to be scanned of the image carrier; a transfer unit that transfers the developed toner image to paper that is being transported; and a fixing unit that fixes the transferred toner image to the paper.

When the optical scanning apparatus of the present invention provided with the heat radiating device of the present invention in which the rotating polygonal mirror is mounted on the bottom face side of the base is disposed in this manner, heat generated in the vicinity of the rotating polygonal mirror that rotates at high speed can be efficiently radiated.

### BRIEF DESCRIPTION OF THE DRAWINGS

FIG. 1 is a schematic cross-sectional view showing image forming apparatus provided with an optical scanning apparatus in which a heat radiating device according to an embodiment of the present invention is mounted.

FIG. 2 is a perspective view showing an embodiment of the optical scanning apparatus in which the heat radiating device according to the present invention is mounted.

FIG. 3A is a schematic plan view of the optical scanning apparatus shown in FIG. 2.

FIG. 3B is a schematic cross-sectional view of the optical scanning apparatus shown in FIG. 2.

FIG. 4 is a bottom view of the optical scanning apparatus shown in FIG. 2.

FIG. 5 is a perspective view of the vicinity of a rotating polygonal mirror viewed from above in the optical scanning apparatus shown in FIG. 2.

FIG. 6 is a perspective view of the vicinity of the rotating polygonal mirror viewed from below in the optical scanning apparatus shown in FIG. 2.

FIG. 7 is a cross-sectional view showing the vicinity of the rotating polygonal mirror in the optical scanning apparatus shown in FIG. 2.

FIG. 8 is an enlarged bottom view of the D portion in FIG. 4.

FIG. 9 is a partially enlarged bottom view of an apparatus casing showing another embodiment of heat radiating fins provided in the heat radiating device according to the present invention.

FIG. 10 is a partially enlarged bottom view of an apparatus casing showing another embodiment of heat radiating fins provided in the heat radiating device according to the present invention.

FIG. 11 is a cross-sectional view showing the vicinity of the rotating polygonal mirror, illustrating another embodiment of the heat radiating device according to the present invention.

FIG. 12 is an enlarged perspective view showing the vicinity of the rotating polygonal mirror, illustrating another embodiment of the heat radiating device according to the present invention.

FIG. 13 is an enlarged perspective view showing the vicinity of the rotating polygonal mirror in a state where an air flow path casing and a heat radiating portion are partially cut out, illustrating another embodiment of the heat radiating device according to the present invention.

FIG. 14 is a table summarizing the experimental results on polygonal mirror trial products provided with heat radiating devices according to the present invention.

FIG. 15A is a plan view showing an example of the shape and the arrangement structure of a conventional heat radiating fin portion that is disposed on a back face of a heat blocking plate.

FIG. 15B is a plan view showing another example of the shape and the arrangement structure of a conventional heat radiating fin portion that is disposed on a back face of a heat blocking plate.

FIG. 15C is a plan view showing another example of the shape and the arrangement structure of a conventional heat radiating fin portion that is disposed on a back face of a heat blocking plate.

### DESCRIPTION OF THE PREFERRED EMBODIMENTS

Hereinafter, embodiments of the present invention will be described with reference to the accompanying drawings. Note that the following embodiments are one example embodying the present invention, and are not to limit the technical scope of the present invention.

Description of the Image Forming Equipment

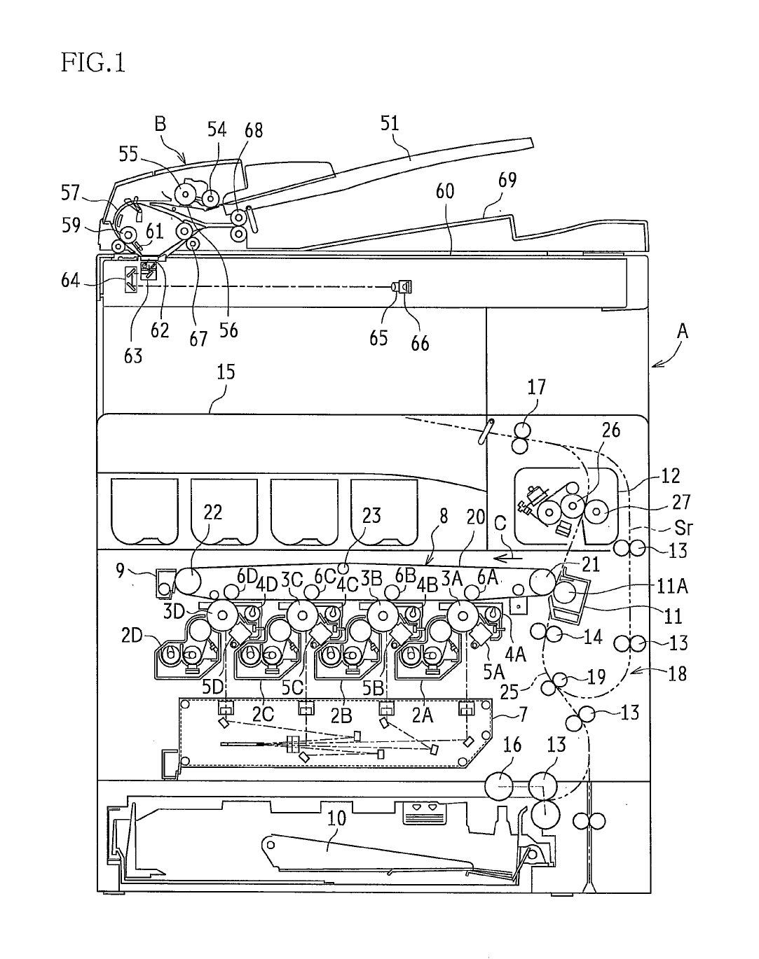

FIG. 1 is a schematic cross-sectional view showing image forming apparatus provided with an optical scanning apparatus in which a heat radiating device according to an embodiment of the present invention is mounted. This image forming apparatus is provided with an original reading unit (an image reading unit) B that reads an image of an original, and an image forming unit A that records an image of an original read by the original reading unit B or an image received from the outside of the equipment on paper in color or in monochrome.

In the original reading unit B, when documents are set on an original set tray 51, a pickup roller 54 is pressed against the surface of the originals and rotated, and, thus, the originals are drawn in from the original set tray 51, then pass through between a separator roller 55 and a separation pad 56 to be separated sheet by sheet, and are each transported to a transport path 57.

On the transport path 57, when the leading edge of the original is brought into contact with a registration roller 59, the leading edge of the original is aligned in parallel to the registration roller 59, and then the original is transported by the registration roller 59, and passes through between an original guide 61 and a reading glass 62. At that time, light from a light source of a first scanning portion 63 is irradiated via the reading glass 62 on the surface of the original, and light reflected by the surface is incident via the reading glass 62 on the first scanning portion 63. The reflected light is reflected by mirrors of the first and the second scanning portions 63 and 64 and guided to an imaging lens 65, and an image of the original is formed by the imaging lens 65 on a charge coupled device (CCD) 66. The CCD 66 reads the image of the original, and outputs image data indicating the image of the original. Furthermore, the original is transported by a transport roller 67, and discharged via paper discharge rollers 68 onto an original discharge tray 69.

Furthermore, an original placed on an original glass flatbed 60 also can be read. Members such as the registration roller 59, the original guide 61, and the original discharge tray 69, and other members thereabove are integrated, forming a cover member that is pivoted in an openable and closable manner on the rear face side of the original reading unit B. When this cover member is opened, the original glass flatbed 60 is exposed and an original can be placed on the original glass flatbed 60. When the original is placed and the cover member is closed, while the first and the second scanning portions 63 and 64 are being moved in the sub-scanning direction, the surface of the original on the original glass flatbed 60 is exposed to light from the first scanning portion 63, light reflected by the surface of the original is guided by the first and the second scanning portions 63 and 64 to the imaging lens 65, and an image of the original is formed by the imaging lens 65 on the CCD 66. At that time, the first and the second scanning portions 63 and 64 are moved while maintaining a predetermined relationship in speed, and the positional relationship between the first and the second scanning portions 63 and 64 is always maintained such that the length of an optical path of the reflected light extending along the surface of the original, the first and the second scanning portions 63 and 64, the imaging lens 65, and the CCD 66 does not change, and, thus, the image of the original is always kept accurately focused on the CCD 66.

The entire image of the original that has been read in this manner is sent as image data to the image forming unit A, and the image is recorded on paper in the image forming unit A.

Meanwhile, the image forming unit A is configured by an optical scanning apparatus 7, development apparatuses (development units) 2, photosensitive drums (image carriers) 3, charging units 5, cleaning apparatuses 4, an intermediate transfer belt apparatus (a transfer unit) 8, a fixing apparatus (a fixing unit) 12, a paper transport apparatus 18, a paper feed tray 10, a paper discharge tray 15, and the like.

Image data processed in the image forming unit A corresponds to a color image using colors consisting of black (K), cyan (C), magenta (M), and yellow (Y), or corresponds to a monochrome image using a monochrome color (e.g., black). Thus, four development apparatuses 2 (2A, 2B, 2C, and 2D), four photosensitive drums 3 (3A, 3B, 3C, and 3D), four charging units 5 (5A, 5B, 5C, and 5D), and four cleaning apparatuses 4 (4A, 4B, 4C, and 4D) are arranged such that four types of latent images corresponding to the respective colors are formed.

The photosensitive drums 3 are arranged substantially in the center of the image forming unit A. The charging units 5 are charging means for uniformly charging the surfaces of the photosensitive drums 3 to a predetermined potential. As the charging units 5, a contact-type charging unit using a roller or brush, or a charger-type charging unit is used.

The optical scanning apparatus 7 is a laser scanning unit (LSU) provided with laser diodes and reflective mirrors, and causes the charged surfaces (faces to be scanned) of the photosensitive drums 3 to be exposed to light according to image data by scanning the surfaces with laser beams, forming electrostatic latent images according to the image data on the surfaces.

The development apparatuses 2 develop the electrostatic latent images formed on the photosensitive drums 3 into toner images with toners (K, C, M, and Y). The cleaning apparatuses 4 remove and recover toner remaining on the surfaces of the photosensitive drums 3 after development and image transfer.

The intermediate transfer belt apparatus 8 disposed above the photosensitive drums 3 is provided with an intermediate transfer belt 20, an intermediate transfer belt drive roller 21, an idler roller 22, intermediate transfer rollers 6 (6A, 6B,6C, and 6D), and an intermediate transfer belt cleaning apparatus 9.

The intermediate transfer belt drive roller 21, the intermediate transfer rollers 6, the idler roller 22 and the like support the intermediate transfer belt 20 in a tensioned state, and circumferentially move the intermediate transfer belt 20 in the arrow C direction.

The intermediate transfer rollers 6 are supported in a rotatable manner near the intermediate transfer belt 20, and pressed via the intermediate transfer belt 20 against the photosensitive drums 3. A transfer bias for transferring the toner images on the photosensitive drums 3 to the intermediate transfer belt 20 is applied to the intermediate transfer rollers 6.

The intermediate transfer belt 20 is disposed so as to be in contact with the photosensitive drums 3A, 3B, 3C, and 3D. The toner images on the surfaces of the photosensitive drums 3A, 3B, 3C, and 3D are sequentially transferred to the intermediate transfer belt 20 and superimposed, and, thus, a color toner image (toner images of the respective colors) is formed. This transfer belt is formed as an endless belt using a film having a thickness of approximately 100 μm to 150 μm.

The toner images are transferred from the photosensitive drums 3 to the intermediate transfer belt 20, using the intermediate transfer rollers 6 pressed against the back face of the intermediate transfer belt 20. In order to transfer the toner images, a high-voltage transfer bias (a high voltage of the polarity (+) opposite the charge polarity (−) of the toner) is applied to the intermediate transfer rollers 6. The intermediate transfer rollers 6 are rollers including a core that is made of a metal shaft (e.g., stainless steel) having a diameter of 8 to 10 mm, and an electrically conductive elastic material (e.g., EPDM, urethane foam, etc.) that covers the surface of the core. The electrically conductive elastic material enables a high voltage to be uniformly applied to paper.

As described above, the toner images on the surfaces of the photosensitive drums 3A, 3B, 3C, and 3D are superimposed on the intermediate transfer belt 20, forming the color toner image represented by the image data. The thus superimposed toner images of the respective colors are transported along the intermediate transfer belt 20, and transferred to paper by a secondary transfer apparatus 11 that is in contact with the intermediate transfer belt 20.

The intermediate transfer belt 20 and a transfer roller 11A of the secondary transfer apparatus 11 are pressed against each other, forming a nip region. Furthermore, a voltage (a high voltage of the polarity (+) opposite the charge polarity (−) of the toner) for transferring the toner images of the respective colors on the intermediate transfer belt 20 to paper is applied to the transfer roller 11A of the secondary transfer apparatus 11. In order to constantly maintain the nip region, one of the transfer roller 11A of the secondary transfer apparatus 11 and the intermediate transfer belt drive roller 21 is made of a hard material (metal, etc.), and the other is made of a soft material such as an elastic roller (an elastic rubber roller, a foamable resin roller, etc.).

The toner images on the intermediate transfer belt 20 may not be completely transferred by the secondary transfer apparatus 11 to paper, and toner may remain on the intermediate transfer belt 20. This residual toner causes toner color mixing in the subsequent step. Thus, the residual toner is removed and recovered by the intermediate transfer belt cleaning apparatus 9. The intermediate transfer belt cleaning apparatus 9 is provided with, for example, a cleaning blade that is in contact with the intermediate transfer belt 20 as a cleaning member, and the back side of the intermediate transfer belt 20 is supported by the idler roller 22 at a position where the cleaning blade is in contact with the intermediate transfer belt 20.

The paper feed tray 10 is a tray in which paper is stored, and is disposed in the lower portion of the image forming unit A. Furthermore, the paper discharge tray 15 disposed in the upper portion of the image forming unit A is a tray in which printed paper is placed facedown.

Furthermore, in the image forming unit A, the paper transport apparatus 18 for transporting paper in the paper feed tray 10 via the secondary transfer apparatus 11 and the fixing apparatus 12 to the paper discharge tray 15 is disposed. The paper transport apparatus 18 has an S-shaped paper transport path 25, and a pickup roller 16, pre-registration rollers 19, registration rollers 14, the fixing apparatus 12, transport rollers 13, paper discharge rollers 17, and the like are arranged along the paper transport path 25.

The pickup roller 16 is a draw-in roller that is disposed at an end portion of the paper feed tray 10 and feeds paper sheet by sheet from the paper feed tray 10 to the paper transport path 25. The transport rollers 13 and the pre-registration rollers 19 are small rollers for promoting and assisting transportation of paper, and arranged at a plurality of positions along the paper transport path 25.

The registration rollers 14 temporarily stop the transported paper, align the leading edge of the paper, and transport the paper at an appropriate timing according to the rotation of the photosensitive drums 3 and the intermediate transfer belt 20 such that the color toner image on the intermediate transfer belt 20 is transferred to the paper at the nip region between the intermediate transfer belt 20 and the secondary transfer apparatus 11.

The fixing apparatus 12 receives the paper to which the toner image has been transferred, and transports the paper such that the paper is nipped in the nip region between a heat roller 26 and a pressure roller 27. The heat roller 26 is controlled so as to be at a predetermined fixing temperature. The heat roller 26 and the pressure roller 27 apply thermo-compression to the paper, and thus melt, mix, and press the toner image transferred to the paper, and thermally fix the toner image to the paper.

The paper to which the toner images of the respective colors have been fixed is discharged by the paper discharge rollers 17 onto the paper discharge tray 15.

Here, a monochrome image can be formed using only an image forming station Pa, and transferred to the intermediate transfer belt 20 of the intermediate transfer belt apparatus 8. This monochrome image is also transferred from the intermediate transfer belt 20 to paper and fixed onto the paper as in the case of the color image.

Furthermore, when performing printing on both faces of paper instead of only a front face, after an image on the front face of the paper is fixed by the fixing apparatus 12, the paper discharge rollers 17 are stopped and then rotated in reverse during transportation of the paper by the paper discharge rollers 17 of the paper transport path 25, the paper is passed through a reverse path Sr where the front and the back of the paper are reversed, and then the paper is guided to the registration rollers 14. Subsequently, as in the case of the front face of the paper, an image is recorded and fixed to the back face of the paper, and the paper is discharged onto the paper discharge tray 15.

Description of the Optical Scanning Apparatus

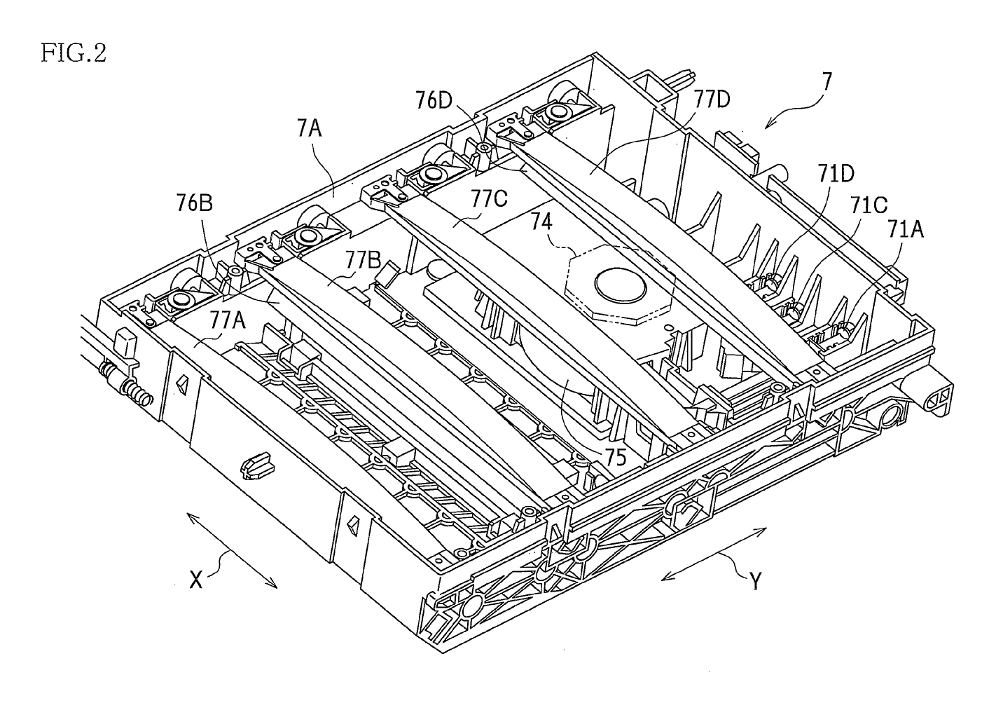

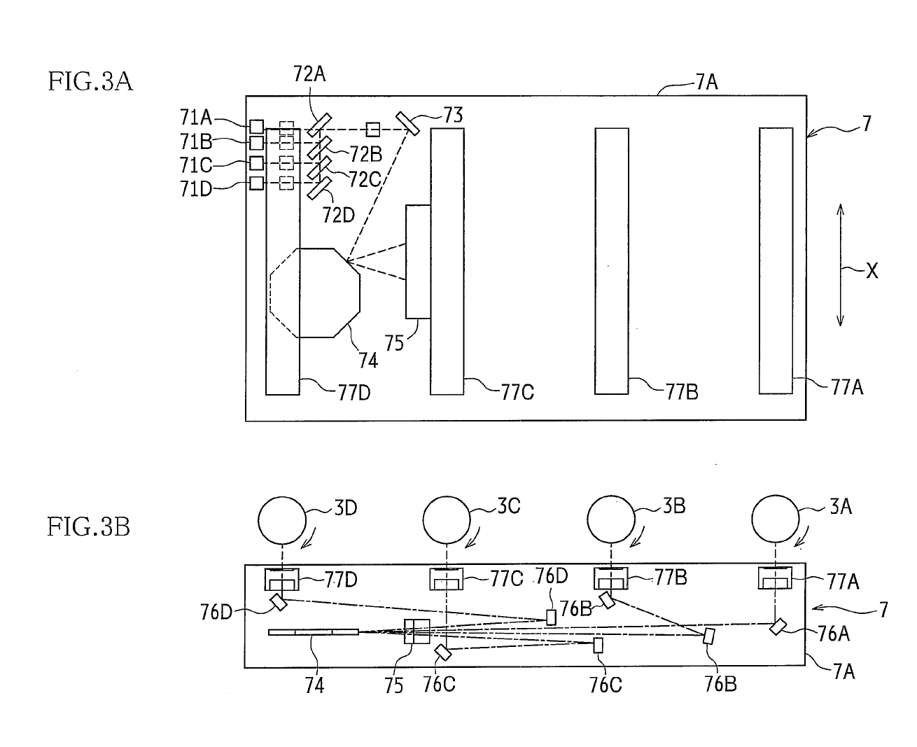

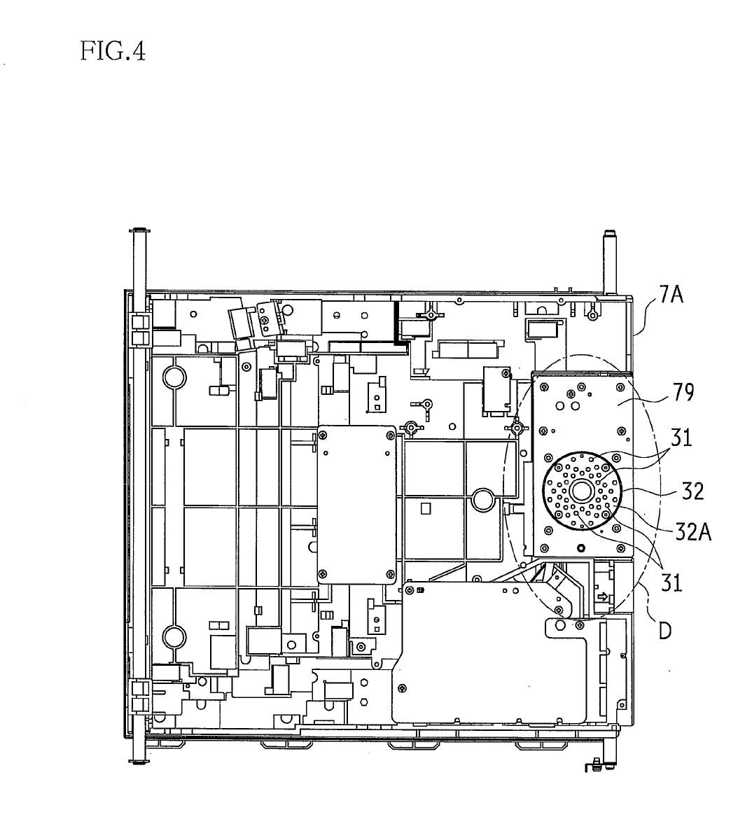

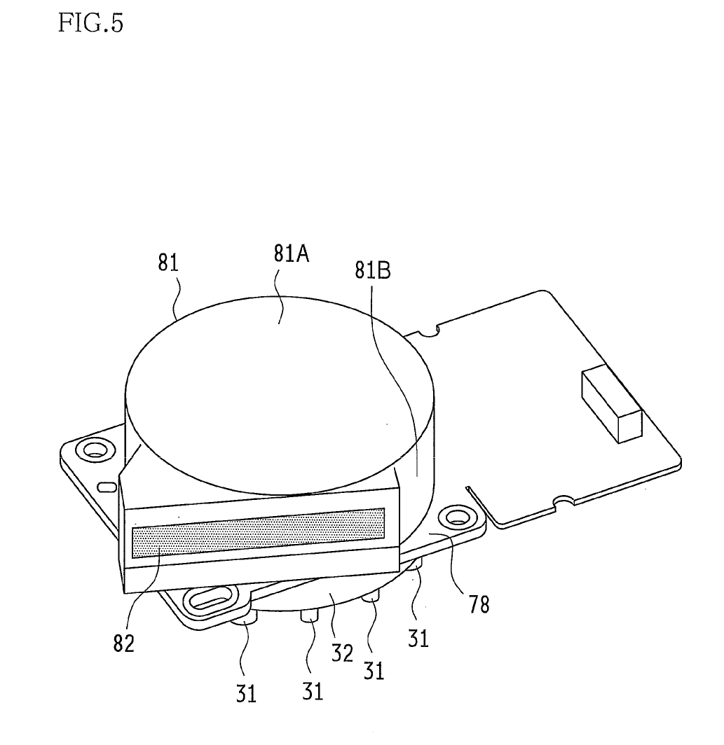

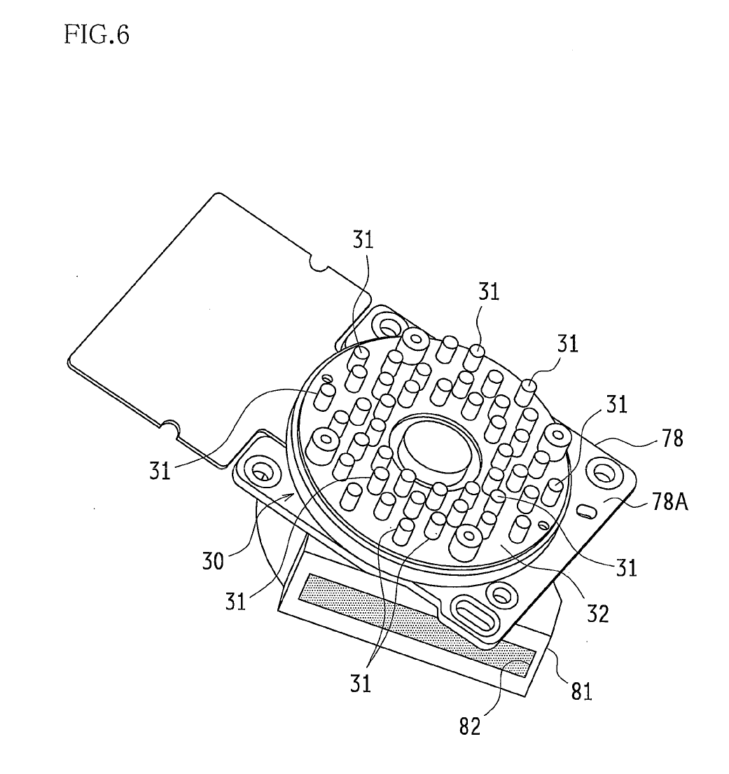

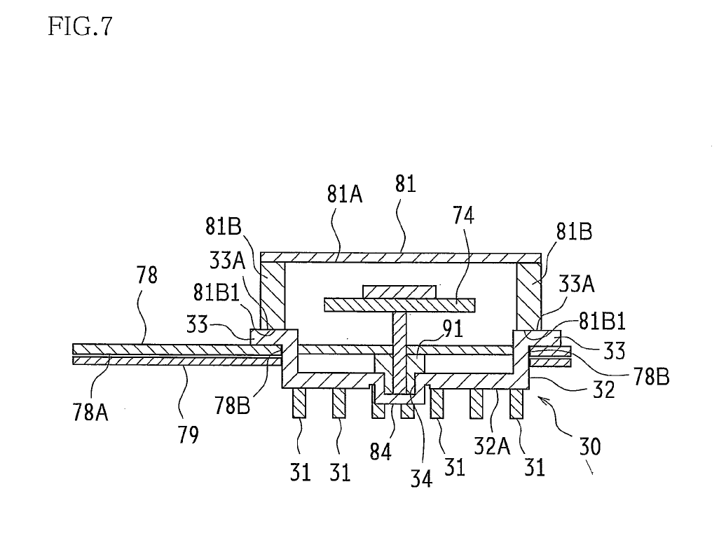

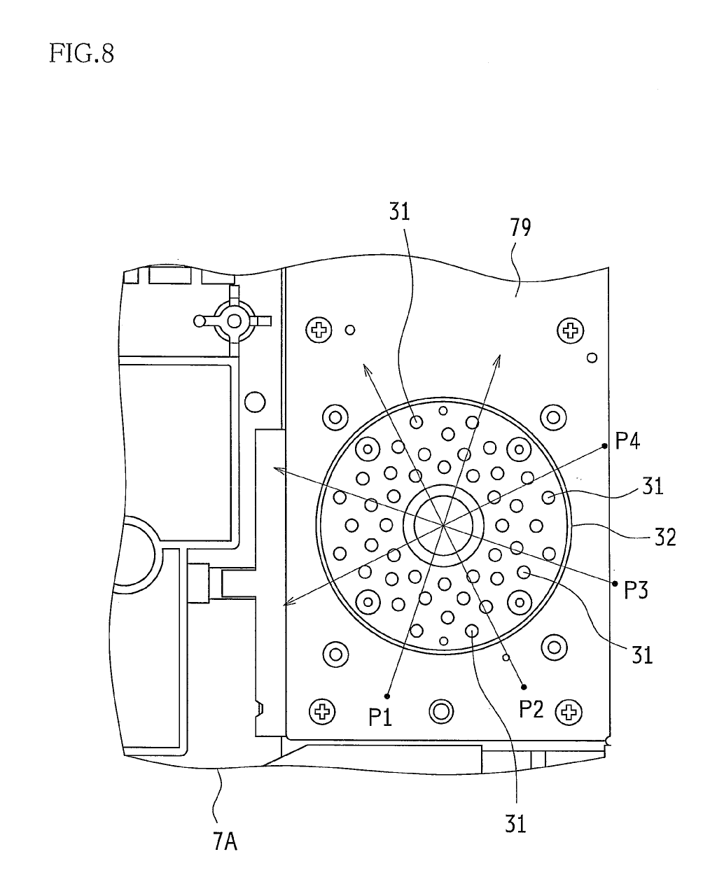

FIG. 2 is a perspective view showing an embodiment of the optical scanning apparatus 7 in which a heat radiating device 30 according to the present invention is mounted. FIGS. 3A and 3B are a schematic plan view and a schematic cross-sectional view of the optical scanning apparatus 7, and FIG. 4 is a bottom view of the optical scanning apparatus 7. FIG. 5 is a perspective view of the vicinity of a rotating polygonal mirror viewed from above, FIG. 6 is a perspective view of the vicinity of the rotating polygonal mirror viewed from below, FIG. 7 is a cross-sectional view showing the vicinity of the rotating polygonal mirror, and FIG. 8 is an enlarged bottom view of the D portion in FIG. 4. Note that, in FIGS. 2, 3A, and 3B, a cover casing that accommodates the rotating polygonal mirror is omitted.

In the optical scanning apparatus 7 according to this embodiment, laser diodes 71 (71A, 71B, 71C, and 71D) that respectively correspond to the colors black (K), cyan (C), magenta (M), and yellow (Y), mirrors 72 (72A, 72B, 72C, and 72D) that reflect laser beams from the laser diodes 71A to 71D, a mirror 73 that reflects the laser beams from the mirrors 72A to 72D, a rotating polygonal mirror (hereinafter, referred to as a “polygonal mirror”) 74 that reflects the laser beams from the mirror 73, a first fθ lens 75 that refracts the laser beams from the polygonal mirror 74, a plurality of mirrors 76 (76A, 76B, 76C, and 76D) that separately reflect the laser beams that have been transmitted through the first fθ lens 75, and four second fθ lenses 77 (77A, 77B, 77C, and 77D) that separately refract the laser beams from the mirrors 76A to 76D are arranged at predetermined positions within an apparatus casing 7A.

The polygonal mirror 74 in this embodiment is in the shape of an 8-sided regular polygonal column, and is rotationally driven at high speed, so that laser beams are reflected by mirrors (reflective faces) of circumferential faces of the polygonal mirror 74 and repeatedly scanned in a main-scanning direction X. As shown in FIG. 7, the polygonal mirror 74 is supportably fixed in a rotatable manner to a mirror board 78. Furthermore, the mirror board 78 is supportably fixed to a support member 79 that is placed and fixed within the apparatus casing 7A with screws or the like (not shown).

In order to reflect and refract the respective laser beams that are repeatedly scanned in the main-scanning direction X, the first fθ lens 75, the mirrors 76, and the second fθ lenses 77 are each formed in a bar-like shape that is made longer in the main-scanning direction X and made shorter in a direction Y orthogonal to the main-scanning direction X, and both ends of these constituent elements are supportably fixed to the apparatus casing 7A.

The laser beam emitted from the laser diode 71C that corresponds to black is sequentially reflected by the mirror 72C, the mirror 72A, and the mirror 73, and is reflected by the polygonal mirror 74 and scanned in the main-scanning direction X. Furthermore, the laser beam is transmitted through the first fθ lens 75, is reflected by the mirror 76A, is transmitted through the second fθ lens 77A, and is incident on the photosensitive drum 3A that corresponds to black.

The laser beam emitted from the laser diode 71D that corresponds to cyan is sequentially reflected by the mirror 72D, the mirror 72A, and the mirror 73, and is reflected by the polygonal mirror 74 and scanned in the main-scanning direction X. Furthermore, the laser beam is transmitted through the first fθ lens 75, is reflected by the two mirrors 76B, is transmitted through the second fθ lens 77B, and is incident on the photosensitive drum 3B that corresponds to cyan.

The laser beam emitted from the laser diode 71B that corresponds to yellow is sequentially reflected by the mirrors 72B and 72A, and the mirror 73, and is reflected by the polygonal mirror 74 and scanned in the main-scanning direction X. Furthermore, the laser beam is transmitted through the first fθ lens 75, is reflected by the two mirrors 76D, is transmitted through the second fθ lens 77D, and is incident on the photosensitive drum 3D that corresponds to yellow.

The laser beam emitted from the laser diode 71A that corresponds to magenta is reflected by the mirror 73, and is reflected by the polygonal mirror 74 and scanned in the main-scanning direction X. Furthermore, the laser beam is transmitted through the first fθ lens 75, is reflected by the two mirrors 76C, is transmitted through the second fθ lens 77C, and is incident on the photosensitive drum 3C that corresponds to magenta.

The photosensitive drums 3A to 3D are rotationally driven in the arrow directions shown in FIG. 3B, and are irradiated with the respective laser beams that are repeatedly scanned in the main-scanning direction X, and, thus, electrostatic latent images are respectively formed on the surfaces of the photosensitive drums 3A to 3D. The electrostatic latent images on the surfaces of the photosensitive drums 3A to 3D are respectively developed into toner images, and these toner images are transferred via the intermediate transfer belt 20 to paper and superimposed, and, thus, a color toner image is formed on the paper.

In the above-described configuration, as shown in FIGS. 5, 6, and 7, in this embodiment, a substantially cylindrical cover casing 81 that covers from above and accommodates the entire polygonal mirror 74 is provided, for example, in order to prevent the entrance of extraneous light or dust and to block motor noise. In the cover casing 81, a laterally long opening portion 82 is provided in a side face portion in the direction in which a scanning laser is emitted, and the opening portion 82 is formed with a slightly wider width than the effective scanning range of a scanning laser beam that has been reflected by the polygonal mirror 74. In the cover casing 81, a ceiling portion 81A is made of disk-shaped sheet metal, and a cylindrical portion 81B that surrounds the ceiling portion 81A is made of aluminum (Al).

Furthermore, on a bottom face 78A side of the mirror board 78 opposing the polygonal mirror 74, the heat radiating device 30 provided with a plurality of heat radiating fins (heat radiating members) 31 is disposed.

The heat radiating device 30 is provided with a substantially disk-shaped fin base (base) 32 that is attached to the mirror board 78, and the plurality of heat radiating fins 31 integrally extend from a bottom face 32A of the fin base 32. The fin base 32 and the heat radiating fins 31 in this embodiment are made of aluminum (Al). As shown in FIGS. 4, 6, and 8, the heat radiating fins 31 are each formed to have a circular transverse section (i.e., to have a columnar shape), and are arranged such that any one of the heat radiating fins 31 is positioned on a straight line in any direction (in any direction parallel to the bottom face 32A) orthogonal to the direction in which the heat radiating fins 31 extend (the direction perpendicular to the bottom face 32A of the fin base 32). FIG. 8 illustrates that any one of the heat radiating fins 31 is always positioned on straight lines that are drawn respectively from four points (P1 to P4) toward the center. That is to say, the arrangement structure is such that air currents cannot flow through in straight lines between the heat radiating fins 31. Accordingly, the area in which air currents are received by the heat radiating fins 31 increases, the heat radiation efficiency increases, and the degree of freedom in designing the arrangement of the heat radiating device 30 itself also increases. Furthermore, since the heat radiating fins 31 are each formed to have a circular transverse section, air that flows through between the heat radiating fins 31 flows smoothly, and flowing air is uniformly brought into contact with all the heat radiating fins 31, and, thus, the heat radiation efficiency can be increased.

Here, a recess portion 34 that is recessed by one step toward the bottom face at the center of the fin base 32 is a holding portion for holding and fixing a motor 91, which is driving means for rotationally driving the polygonal mirror 74.

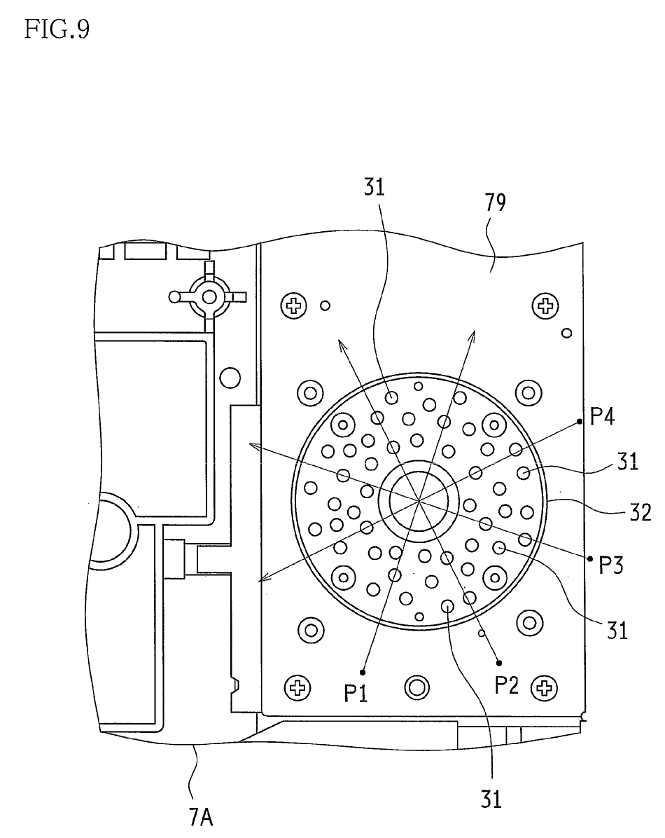

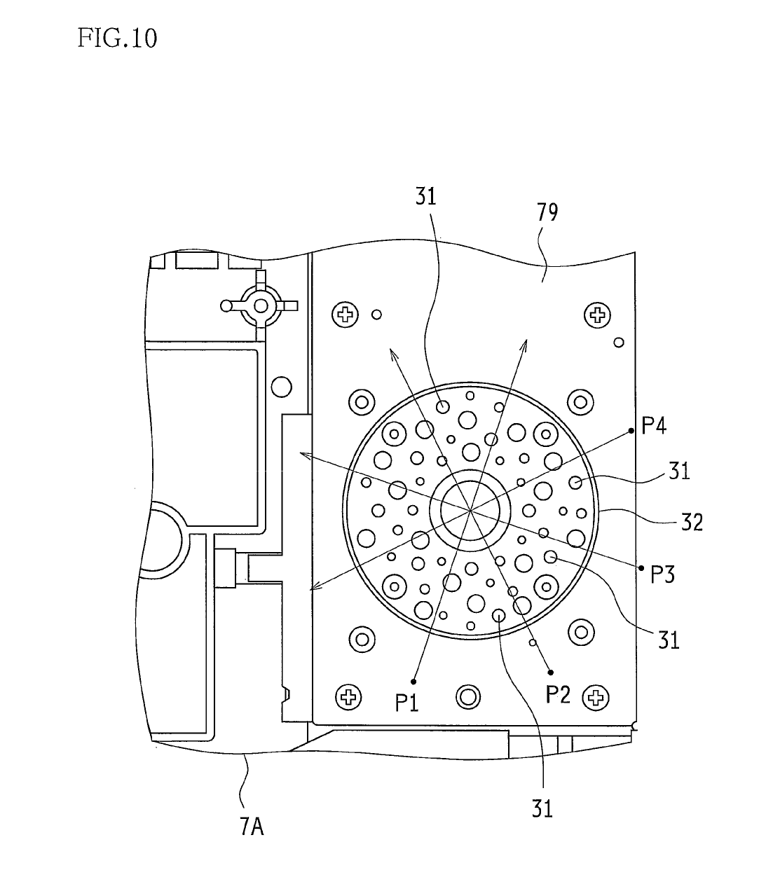

FIGS. 9 and 10 are partially enlarged bottom views of the apparatus casing 7A showing another embodiment of the heat radiating fins 31.

Although the heat radiating fins 31 are arranged in a regular manner (symmetrically arranged in vertical and lateral directions) in the embodiment shown in FIG. 8, the arrangement of the heat radiating fins 31 is not limited to such a regular arrangement. For example, the arrangement of the heat radiating fins 31 may be an irregular random arrangement as long as air currents cannot flow through in straight lines between the heat radiating fins 31. FIG. 9 shows an example in which the heat radiating fins 31 are arranged at random.

Furthermore, the diameters of the heat radiating fins 31 do not have to be the same, and the diameters of the heat radiating fins 31 may be made different from each other with a design in which air currents cannot flow through in straight lines between the heat radiating fins 31. FIG. 10 shows an example in which the diameters of the heat radiating fins 31 are made different from each other.

As shown in FIG. 7, a ring-shaped cover receiving portion 33 that is projected by one step is formed from the circumference of the fin base 32. When the cover receiving portion 33 is fitted from above so as to be brought into contact with a circumferential upper edge of a circular opening portion 78B formed in the mirror board 78, the fin base 32 is attached and fixed to the mirror board 78. Then, a lower end face (a joint face) 81B1 of the cylindrical portion 81B of the cover casing 81 is directly joined (placed and fixed) to an upper face (a joint face) 33A of the cover receiving portion 33.

In this embodiment, a joint face between the lower end face 81B1 of the cylindrical portion 81B of the cover casing 81 and the upper face 33A of the cover receiving portion 33 of the fin base 32 is formed as a smooth face. When the joint face is formed as a smooth face in this manner by mirror finish, the contact area on the joint face between the cover casing 81 and the fin base 32 increases, and, thus, the thermal conduction from the cover casing 81 via the fin base 32 to the heat radiating fins 31 is more efficiently performed.

Note that the heat radiation effects obtained by installing the heat radiating device 30 provided with the plurality of heat radiating fins 31 on the bottom face 78A side of the mirror board 78 opposing the polygonal mirror 74, and by forming the joint face between the lower end face 81B1 of the cylindrical portion 81B of the cover casing 81 and the upper face 33A of the cover receiving portion 33 of the fin base 32 as a smooth face will be described at the end with reference to experimental results.

Another Embodiment of the Heat Radiating Device 30

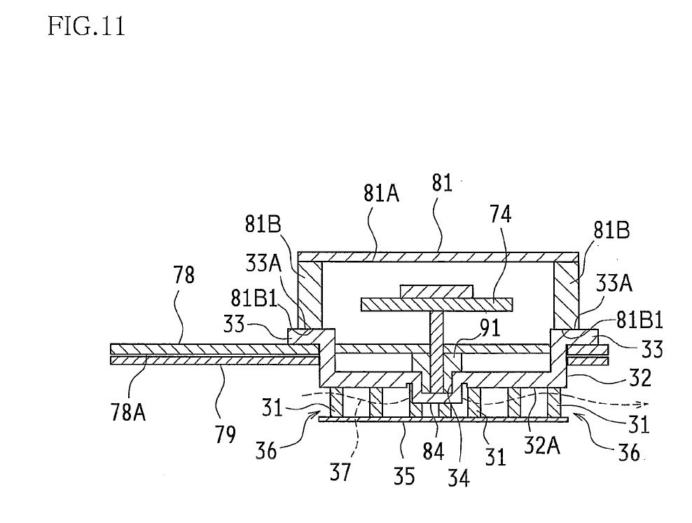

FIG. 11 is a cross-sectional view showing the vicinity of the rotating polygonal mirror, illustrating another embodiment of the heat radiating device 30.

The heat radiating device 30 of this embodiment is provided with a heat radiating portion 35 that is in contact with the tip ends of the heat radiating fins 31 of the heat radiating device 30. The heat radiating portion 35 is formed in the shape of a disk having substantially the same diameter as the fin base 32, and is made of, for example, sheet metal or the like. Furthermore, a portion corresponding to a side area between the heat radiating portion 35 and the fin base 32 is an open portion 36 that is fully open. When the heat radiating portion 35 is disposed in this manner, an air flow path 37 (indicated by the dotted line in the drawing) is formed such that air (air current) that flows through between the fin base 32 and the heat radiating portion 35 always flows through between the heat radiating fins 31, and, thus, the heat radiation effect through the heat exchange with the heat radiating fins 31 can be increased. Furthermore, since the heat radiating portion 35 is in contact with the tip ends of the heat radiating fins 31, the heat radiation effect through the thermal conduction from the heat radiating fins 31 to the heat radiating portion 35 also can be obtained.

Here, the heat radiation effect obtained by installing the heat radiating portion 35 will be finally described with reference to experimental results.

Another Embodiment of the Heat Radiating Device 30

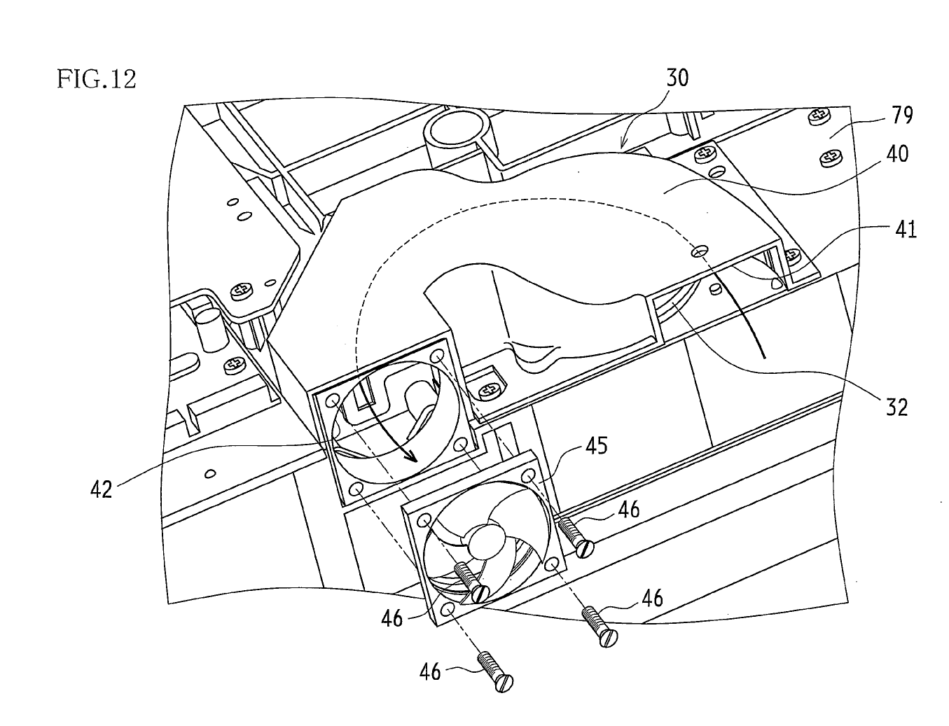

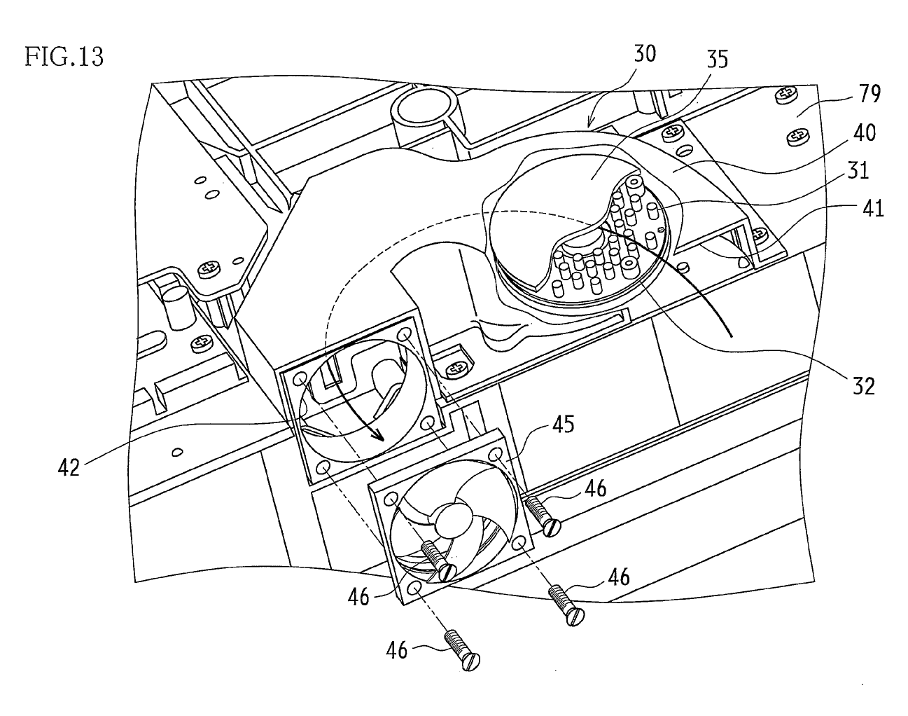

FIGS. 12 and 13 are enlarged perspective views showing the vicinity of the rotating polygonal mirror, illustrating another embodiment of the heat radiating device 30. Here, FIG. 13 shows the air flow path casing 40 (described later) and the heat radiating portion 35 partially cut out.

In the heat radiating device 30 of this embodiment, in addition to the configuration of the heat radiating device 30 shown in FIG. 11, an air flow path casing 40 that accommodates the heat radiating fins 31 and the heat radiating portion 35, and forms an air flow path is disposed on the bottom face of the support member 79 including the fin base 32. One opening portion 41 that functions as an outside air inlet opening and another opening portion 42 that functions as an outside air outlet opening are arranged in the side face of the air flow path casing 40, and an air blowing fan (air blowing portion) 45 for drawing outside air from the first opening portion 41 to the second opening portion 42 is attached and fixed to the second opening portion 42 that functions as the outside air outlet opening, for example, by screws 46.

When the air flow path casing 40 that functions as an air blowing path is disposed so as to entirely cover the heat radiating fins 31 and the heat radiating portion 35, and the air blowing fan 45 is provided in this manner, the outside air can be efficiently guided to the heat radiating fins 31. Accordingly, the heat radiation effect by the heat radiating fins 31 can be further increased.

Examination of the Heat Radiation Effects

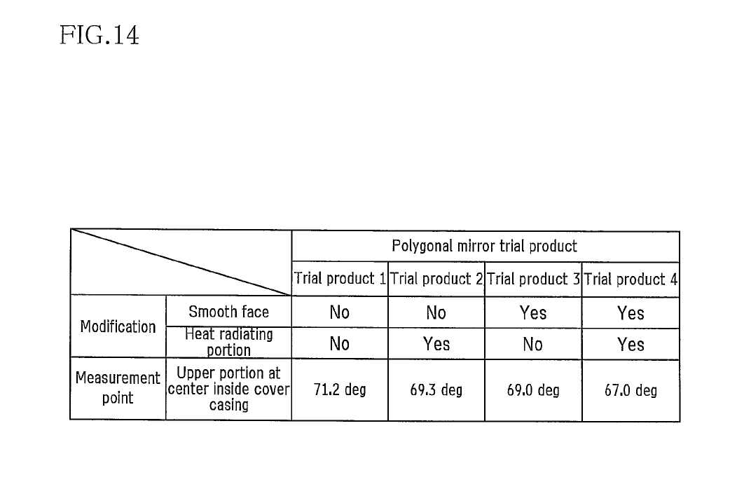

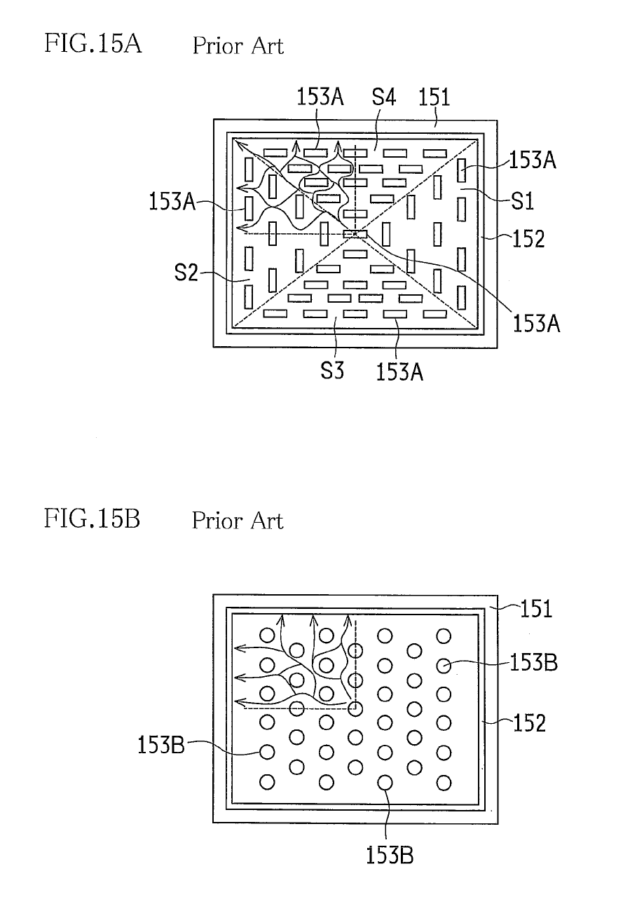

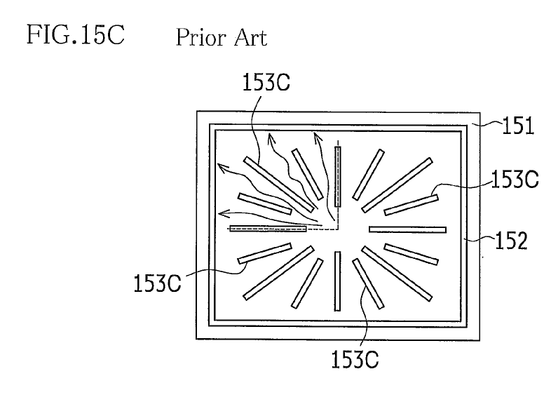

In order to check the heat radiation effects obtained by installing the thus configured heat radiating device 30 and by forming the joint face between the cover casing 81 and the fin base 32 as a smooth face, the present inventors produced optical scanning apparatuses in which the thus configured heat radiating device 30 was actually mounted, arranged the optical scanning apparatuses in image forming apparatus, and conducted an experiment on heat radiation effects. FIG. 14 is a table summarizing the experimental results. In the table, “Yes” and “No” indicate the presence or absence of modification (whether or not a smooth face has been formed, and whether or not a heat radiating plate has been attached), wherein “No” indicates that modification has not been performed, and “Yes” indicates that modification has been performed.

In this experiment, polygonal mirror trial products provided with the heat radiating device 30 having the structures shown in FIGS. 5 and 6 were produced, and mounted in optical scanning apparatuses. The following four types of products were produced as polygonal mirror trial products.

Trial product 1: The joint face between the lower end face 81B1 of the cylindrical portion 81B of the cover casing 81 and the upper face 33A of the cover receiving portion 33 of the fin base 32 was not formed as a smooth face (i.e., was kept as a rough face having slight unevenness), and the heat radiating portion 35 was not provided.

Trial product 2: The joint face between the lower end face 81B1 of the cylindrical portion 81B of the cover casing 81 and the upper face 33A of the cover receiving portion 33 of the fin base 32 was not formed as a smooth face (i.e., was kept as a rough face having slight unevenness), and the heat radiating portion 35 was provided.

Trial product 3: The joint face between the lower end face 81B1 of the cylindrical portion 81B of the cover casing 81 and the upper face 33A of the cover receiving portion 33 of the fin base 32 was formed as a smooth face (i.e., was mirror finished), and the heat radiating portion 35 was not provided.

Trial product 4: The joint face between the lower end face 81B1 of the cylindrical portion 81B of the cover casing 81 and the upper face 33A of the cover receiving portion 33 of the fin base 32 was formed as a smooth face (i.e., was mirror finished), and the heat radiating portion 35 was provided.

In the experiment, optical scanning apparatuses in which the above-described four types of polygonal mirror trial products were respectively mounted were operated, and the maximum temperatures during the operation were measured. The measurement was performed at the center of the lower face of the ceiling portion 81A of the cover casing 81, that is, at one point above the polygonal mirror 74 inside the cover casing 81. Furthermore, the ambient temperature during the measurement was set to 35 degrees.

As a result of the experiment, as shown in FIG. 14, the temperature inside the cover casing in Trial product 1 was 71.2 degrees. On the other hand, in Trial product 2 in which the heat radiating portion 35 was provided, the temperature inside the cover casing was 69.3 degrees, i.e., lower by 1.9 degrees than that in Trial product 1. Furthermore, in Trial product 3 in which the joint face was formed as a smooth face, the temperature inside the cover casing was 69.0 degrees, i.e., lower by 2.2 degrees than that in Trial product 1, and lower by 0.3 degrees than that in Trial product 2. Furthermore, in Trial product 4 in which the joint face was formed as a smooth face and the heat radiating portion 35 was provided, the temperature inside the cover casing was 67.0 degrees, i.e., lower by 4.2 degrees than that in Trial product 1, lower by 2.3 degrees than that in Trial product 2, and lower by 2.0 degrees than that in Trial product 3.

The above-described results proved that sufficient heat radiation effects can be obtained by installing the heat radiating device 30 of the present invention, and by forming the joint face between the cover casing 81 and the fin base 32 as a smooth face.

Although this experiment was conducted only on one machine type, it can be easily assumed that similar tendencies as in the above-described experimental results are obtained also with other machine types where the arrangement structure of the heat radiating device 30 varies.

The present invention may be embodied in various other forms without departing from the spirit or essential characteristics thereof. The embodiments disclosed in this application are to be considered in all respects as illustrative and not limiting. The scope of the present invention is indicated by the appended claims rather than by the foregoing description. All variations and modifications falling within the meaning and range of equivalency of the claims are intended to be embraced therein.

### DESCRIPTION OF REFERENCE NUMERALS

A Image forming unit
B Original reading unit (image reading unit)
1 Heat radiating device
2 (2A, 2B, 2C, 2D) Development apparatus (development unit)
3 (3A, 3B, 3C, 3D) Photosensitive drum (image carrier)
4 (4A, 4B, 4C, 4D) Cleaning apparatus
5 (5A, 5B, 5C, 5D) Charging unit
6 (GA, 6B, 6C, 6D) Intermediate transfer roller
7 Optical scanning apparatus
7A Apparatus casing
8 Intermediate transfer belt apparatus (transfer unit)
10 Paper feed tray
11 Secondary transfer apparatus (transfer unit)
12 Fixing apparatus (fixing unit)
13 Transport roller
14 Registration roller
15 Paper discharge tray
16 Pickup roller
17 Paper discharge roller
18 Paper transport apparatus
19 Pre-registration roller
20 Intermediate transfer belt
25 Paper transport path
26 Heat roller
27 Pressure roller
30 Heat radiating device
31 Heat radiating fin (heat radiating member)
32 Fin base (base)
32A Bottom face
33 Cover receiving portion
33A Upper face (joint face)
34 Recess portion (holding portion)
35 Heat radiating portion
36 Open portion
37 Air flow path
40 Air flow path casing
41, 42 Opening portion
45 Air blowing fan (air blowing portion)
46 Screw, etc.
51 Original set tray
54 Pickup roller
55 Separator roller
56 Separation pad
57 Transport path
59 Registration roller
60 Original glass flatbed
61 Original guide
62 Reading glass
63 First scanning portion
64 Second scanning portion
65 Imaging lens
66 CCD
67 Transport roller
68 Paper discharge roller
69 Original discharge tray
71A to 71D Laser diode
72A to 72D Mirror
73 Mirror
74 Polygonal mirror (rotating polygonal mirror)
75 First fθ lens
76A to 76D Mirror
77 (77A to 77D) Second fθ lens
78 Mirror board
78A Bottom face
78B Opening portion
79 Support member
81 Cover casing
81A Ceiling portion
81B Cylindrical portion
81B1 Lower end face (joint face)
91 Motor

What is claimed is:

1. A heat radiating device, comprising:
a base on which a heat generating member is mounted; and
a plurality of heat radiating members that integrally extend from a bottom face of the base;
wherein the heat radiating members are each formed to have a circular transverse section, and are arranged such that any one of the heat radiating members is positioned on a straight line in any direction orthogonal to a direction in which the heat radiating members extend.

2. The heat radiating device, according to claim 1, further comprising: a heat radiating portion that is in contact with tip ends of the heat radiating members;
wherein a portion corresponding to a side area between the heat radiating portion and the base is an open portion that is fully open.

3. The heat radiating device, according to claim 1,
wherein an air flow path casing that accommodates the heat radiating members and forms an air flow path is provided on the bottom face of the base, and
an air blowing portion that draws outside air from one opening portion to another opening portion of the air flow path casing is provided near the air flow path casing.

4. The heat radiating device, according to claim 1,
wherein a cover casing that accommodates the heat generating member is provided on an upper face of the base, and
a joint face between the cover casing and the base is formed as a smooth face.

5. An optical scanning apparatus, comprising the heat radiating device according to claim 1,
wherein the heat generating member is a rotating polygonal mirror that deflects and scans a laser beam from a light source.

6. Image forming equipment, comprising:
the optical scanning apparatus according to claim 5;
an image carrier;
a development unit that develops, into a toner image, an electrostatic latent image that has been formed by the laser beam from the optical scanning apparatus scanning a face to be scanned of the image carrier;
a transfer unit that transfers the developed toner image to paper that is being transported; and
a fixing unit that fixes the transferred toner image to the paper.
